(19) United States
(12) Patent Application Publication
(10) Pub. No.: US 2014/0230315 A1
(43) Pub. Date: Aug. 21, 2014

(54) System and Method for Cleaning Fuel on Egress From Fuel Tank

(71) Applicant: CATERPILLAR, Peoria, IL (US)

(72) Inventors: Jeffrey R. Ries, Metamora, IL (US); Christopher L. Armstrong, Washington, IL (US); John R. Jones, Crever Coeur, IL (US)

(73) Assignee: Caterpillar Inc., Peoria, IL (US)

(21) Appl. No.: 13/772,963

(22) Filed: Feb. 21, 2013

(51) Int. Cl. B01D 35/00

(52) U.S. Cl. CPC B01D 35/005
USPC 44/300; 210/335

(57) ABSTRACT

A filtered fuel system in a fuel system is disclosed. The filtered fuel system may include a strainer connected to a fuel tank opening of a fuel tank, the strainer removing a first type of contaminant. The filtered fuel system may additionally include a fuel filter positioned within a sump of the fuel tank, the fuel filter filtering a second type of contaminant and connected to a filter opening of the fuel tank through a filter shaft.

### TECHNICAL FIELD OF THE DISCLOSURE

The present disclosure relates to fuel systems and, more particularly, relates to filtration employed in fuel systems for cleaning fuel on egress from the fuel tank.

### BACKGROUND OF THE DISCLOSURE

Fuel system contamination can cause serious problems in any engine. Modern high-performance, low-emissions models are especially vulnerable to contaminants. Generally speaking, fuel contaminants can be described as small to microscopic particles suspended in any fuel that are typically measured in units called microns. One micron is equivalent to one-millionth of a meter. Various types of contaminants can be found in fuel. For example, dirt and dust can be present, which can cause fungi growth and cloudiness. Rust can accumulate in fuel flowing through rusted hoses and fuel lines corroding or clogging components, such as, injectors and control valves of an engine. Excessive water in fuel can cause algae formation while certain extraneous particulates can affect fuel stability.

Such contaminants in fuel are common and can cause premature engine wear, reduce component life, reduce performance and even cause sudden engine failure. As critical components wear prematurely, engine power drops off, fuel consumption rises, emissions increase and the odds of a costly breakdown rise dramatically. In at least some occasions, contaminants can be as abrasive as the materials used to machine parts in the manufacturing process of an engine. Accordingly, alleviating or possibly even completely eliminating contamination from fuel before fuel reaches the engine is highly desirable. These issues may be particularly acute in remote locales where fuel is stored on construction sites to power construction equipment or in nations or regions where fuel quality guidelines are either not stringent or are loosely enforced.

While the effects of dirty fuel can be minimized by using proper storage, handling, maintenance and service processes, such methods are often not followed, or even if followed may not be sufficient and may need to be augmented by other procedures. Techniques for minimizing and/or removing contaminants in fuel have been proposed in the past. One technique employs specialized external pumps for cleaning and filtering fuel before fuel even enters a fuel tank for combustion and/or storage. Although this technique may be effective in removing some contaminants, not all contaminants are removed, which may nonetheless find their way into the fuel tank. Furthermore, more contaminants may accumulate in the fuel from the point of filtration up to the point of the fuel entering the fuel tank. Contaminants may even accumulate in the fuel stored within the fuel tank, due to corrosion of the fuel tank walls and other components thereof, or contaminants entering the fuel tank when the fuel tank cap is opened. Such contaminants may find their way through the fuel line into the engine and may cause the problems mentioned above.

Accordingly, it would be advantageous if an improved filtration system were developed. It would be beneficial if such a system could filter fuel such that any contaminants accumulated within the fuel tank were filtered before the fuel reaches the engine.

### SUMMARY OF THE DISCLOSURE

In accordance with one aspect of the present disclosure, a filtered fuel system is disclosed. The filtered fuel system may include a strainer connected to a fuel tank opening of a fuel tank, the strainer removing a first type of contaminant. The filtered fuel system may also include a fuel filter positioned within a sump of the fuel tank, the fuel filter filtering a second type of contaminant and connected to a filter opening of the fuel tank through a filter shaft.

In accordance with another aspect of the present disclosure, a method of filtering fuel is disclosed. The method may include providing a fuel filter connected to a filter shaft, assembling the fuel filter within a sump of a fuel tank and pouring fuel through a fuel tank opening of the fuel tank. The method may also include filtering the fuel through the fuel filter in an inside-out flow.

In accordance with yet another aspect of the present disclosure, a fuel system is disclosed. The fuel system may include a fuel tank having a fuel tank body, a fuel tank opening, a filter opening, and a sump formed in a recess on a bottom surface of the fuel tank body. The fuel system may also include a fuel filter positioned within the sump of the fuel tank and connected to one end of a filter shaft, a second end of the filter shaft connected to a cover covering the filter opening and a strainer fitted to the fuel tank opening.

### BRIEF DESCRIPTION OF THE DRAWINGS

FIG. 1 is a schematic perspective view of a machine having a fuel tank employing a fuel filter, in accordance with at least some embodiments of the present disclosure;

FIG. 2 is a cross-sectional view of the fuel tank taken along lines 2-2 of FIG. 1;

FIG. 3 is a schematic front view of FIG. 1 showing a first embodiment of disposing the fuel filter within a sump of the fuel tank;

FIG. 4 is a schematic front view of FIG. 1 showing a second embodiment of disposing the fuel filter within the sump of the fuel tank;

FIG. 5 is a flowchart showing a method of filtering fuel through the fuel filter of FIGS. 1-4;

FIG. 6 is a schematic view illustrating connecting a filter shaft of the fuel filter to a cover of the fuel tank, in accordance with at least some embodiments of the present disclosure; and

FIG. 7 is an exploded view of FIG. 6.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents along within the spirit and scope of the present disclosure.

### DETAILED DESCRIPTION OF THE DISCLOSURE

A fuel system having a fuel tank and a fuel filter for filtering fuel are disclosed. While not exclusive, such a fuel system can be effectively employed in various machines used in construction, earth moving, and agriculture fields, including but not limited to track-type tractors, excavators, graders, rollers, off-highway trucks, pipe layers and loaders.

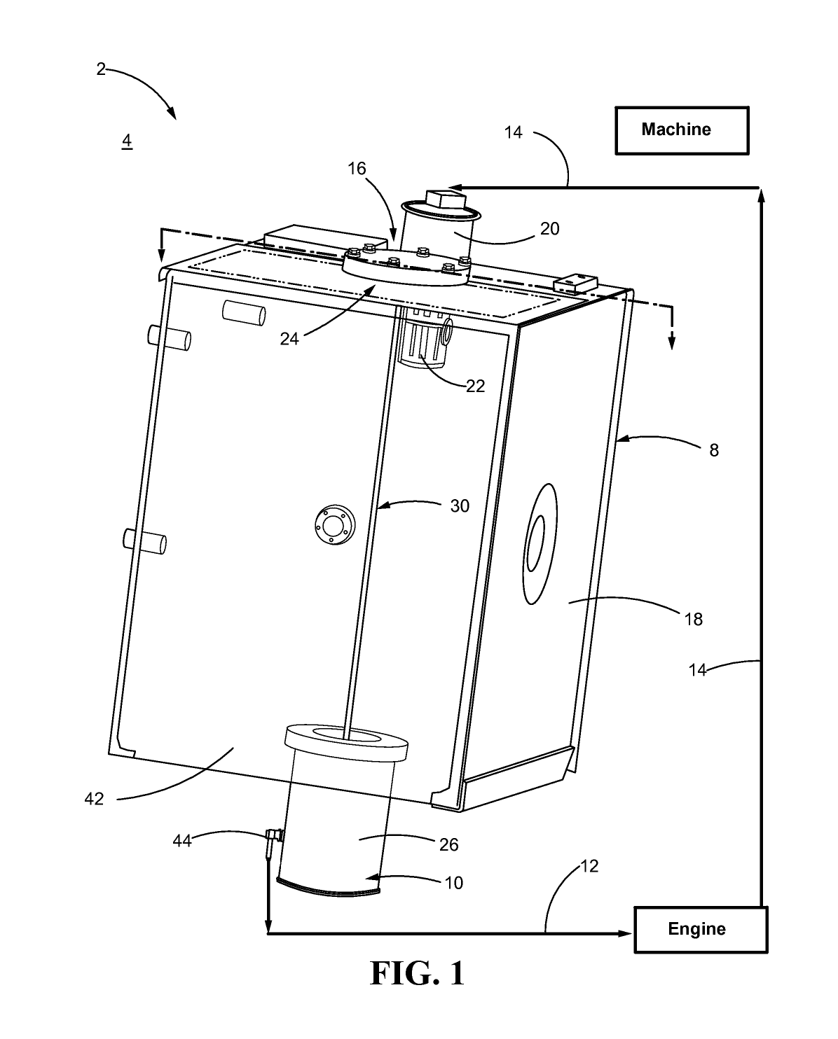

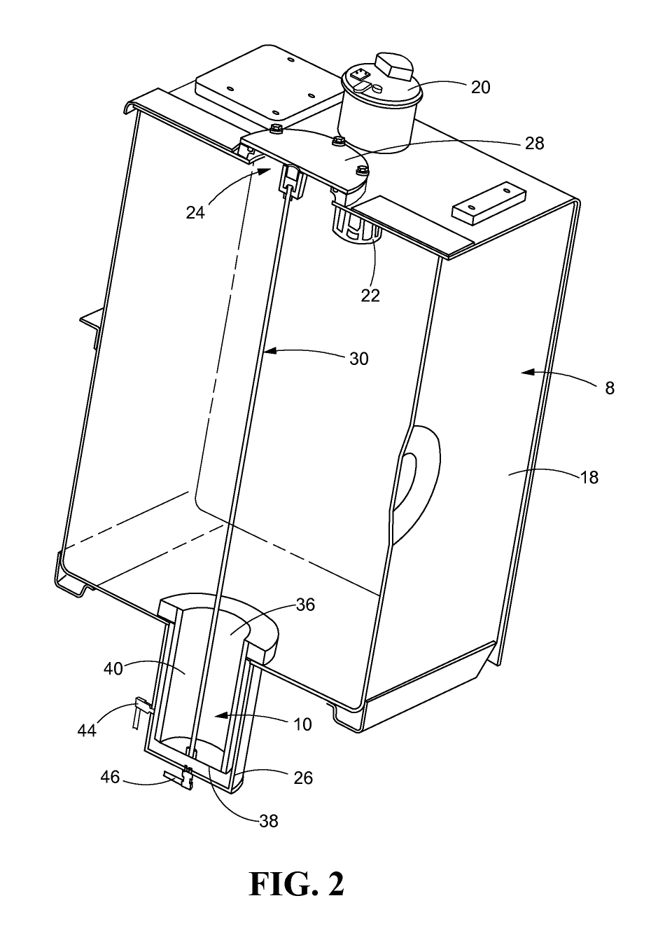

Referring now to FIG. 1, a fuel system 2 is shown, in accordance with at least some embodiments of the present disclosure. As shown, the fuel system 2 may be part of a machine 4 having an engine 6 that utilizes fuel from a fuel tank 8 to run and operate the machine. The fuel tank 8 in turn may employ a fuel filter 10, described in greater detail below with respect to FIGS. 2-4, for filtering fuel therein. Filtered fuel from the fuel tank 8 may be passed through a fuel line 12 into the engine 6 for combustion and any remaining non-combusted fuel from the engine 6 may be returned to the fuel tank 8 via return fuel line 14 for re-filtration and re-combustion.

The machine 4 may be any of a variety of machines, such as those mentioned above, while the engine 6 may be any of a variety of engines, such as, diesel engines, internal combustion engines, hybrid engines and the like that are commonly employed in work machines, such as the machine 4. With respect to the fuel tank 8, while all of the components thereof have not been shown, a typical fuel tank of the type that may be employed within the machine 4 for purposes of the present disclosure may include a fuel tank opening 16 for filling fuel (through a fuel nozzle, not shown) and storing that fuel within a fuel tank body 18. The fuel tank opening 16 may be covered and protected by a fuel tank cap 20. A strainer 22 may be attached to the fuel tank opening 16 and/or the fuel tank cap 20 for removing certain types of contaminants from the fuel entering the fuel tank 8. The fuel tank 8 may additionally include a filter opening 24, which as described below, may be employed for installing, as well as replacing the fuel filter 10 from the fuel tank. The fuel tank 8 may be a stand-alone structure or may be mounted in or on a machine (e.g., the machine 4), such as but not limited to those listed above.

With respect to the fuel tank opening 16 and the fuel tank cap 20, the configuration and, particularly, the shape and size thereof, as well as the manner of securing the fuel tank cap to the fuel tank opening may vary depending upon several factors, such as, the type of the fuel tank 8, the type of fuel stored within the fuel tank, the shape and size of the nozzle employed for filling fuel through the fuel tank opening, the shape and size of the machine using the fuel tank, etc. For example, in some embodiments, the fuel tank opening 16 may be provided with external threads on a neck portion thereof, which may be designed to mate and lock with corresponding internal threads on the fuel tank cap 20. In other embodiments, the fuel tank opening 16 may have friction nubs and the fuel tank cap 20 may be frictionally snapped to the fuel tank opening. In alternate embodiments, other commonly employed mechanisms for securing the fuel tank cap 20 to the fuel tank opening 16 may be employed.

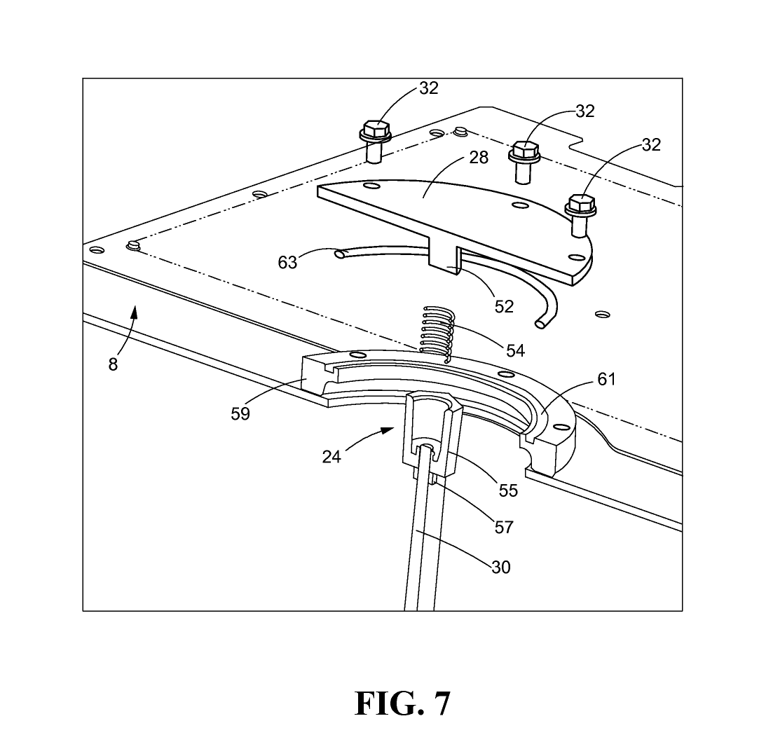

Relatedly, the configuration of the filter opening 24 may vary. As described above, the filter opening 24 may primarily be employed for installing the fuel filter 10 within a sump 26 of the fuel tank 8. The filter opening 24 may additionally be employed for removing and replacing the fuel filter 10 from the fuel tank 8. The size and shape of the filter opening 24 may, thus, vary depending upon the size and shape of the fuel filter 10. In at least some embodiments, the filter opening 24 may be covered and protected by a cover 28 and the fuel filter 10 may be connected to the cover via a filter shaft 30, in a manner described below. Similar to the fuel tank cap 20, the cover 28 may be secured to the filter opening 24 in a variety of ways. In some embodiments, frictional nubs or threaded connections may be employed or, as shown, the cover may be bolted by a plurality of bolts 32 at least indirectly to the surface of the fuel tank body 18. A sealing mechanism 34 (See FIG. 7), such as, an O-ring, may be provided between the cover 28 and the surface of the fuel tank body 18 for providing a tight leak-proof fit, as will be described further below.

In addition to the fuel tank opening 16 and the fuel tank cap 20, as well as the filter opening 24 and the fuel filter 10, the fuel tank 8 and particularly, the fuel tank body 18 of the fuel tank may be equipped with several other components, such as, a fuel sensor for sensing the level of the fuel within the fuel tank body 18 and various vents, gauges, hose assemblies, nozzles etc. Although these components are not shown and/or fully described, they are contemplated in combination or conjunction with the fuel tank 8 and are considered within the scope of the present disclosure. Moreover, it will also be understood that portions of the fuel tank body 18 have been shown as transparent merely for explanation purposes. Although the fuel tank body (or portions thereof) 10 may indeed be transparent, this need not and likely is not the case. In at least some embodiments, the fuel tank body 18 (or portions thereof) may be opaque or translucent.

Furthermore, the shape, size and material of the fuel tank 8 may vary depending upon the application of the fuel tank. For example, in one embodiment, the fuel tank 8 may be seven hundred and sixty millimeters (760 mm) long, six hundred and thirty millimeters (630 mm) wide and eight hundred and sixty two millimeters (862 mm) deep. In other embodiments, the size of the fuel tank 8 may vary. Moreover, and as mentioned above, the fuel tank 8 may be representative of a variety of fuel tanks, such as, in-machine fuel tanks, above-ground or under-ground bulk storage stationary fuel tanks employed on construction sites, tanker trucks in aviation, marine and other commercial transportation fleet re-fueling, etc. The fuel tank 8, whether in-machine or bulk storage, may be employed for storing fuels, such as, gasoline, diesel fuel, kerosene or any other type of liquid fuel that may require filtration.

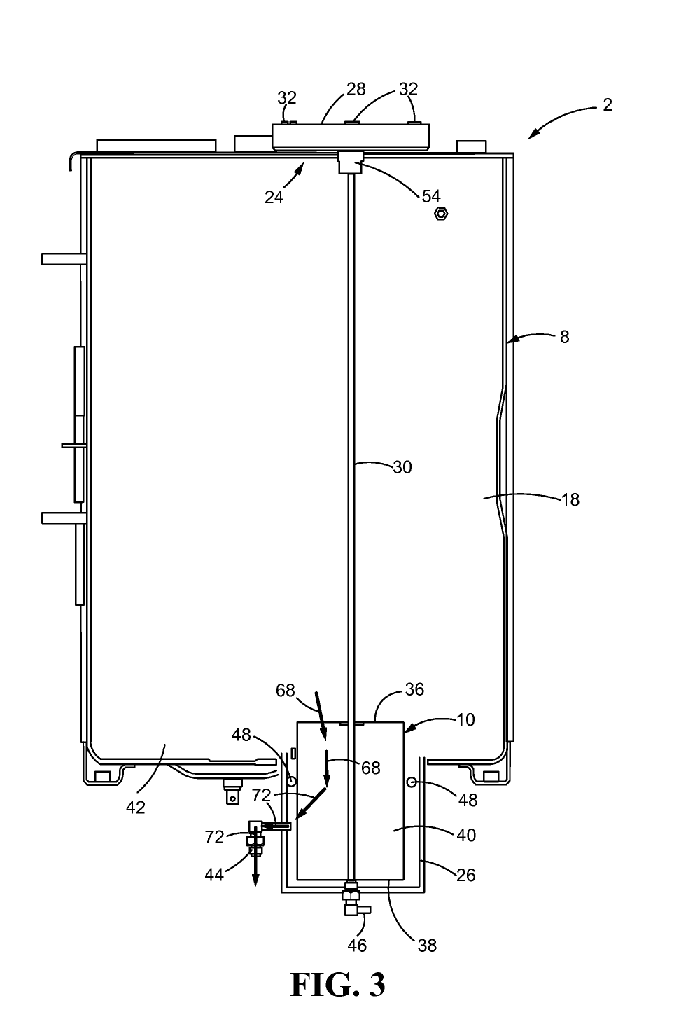

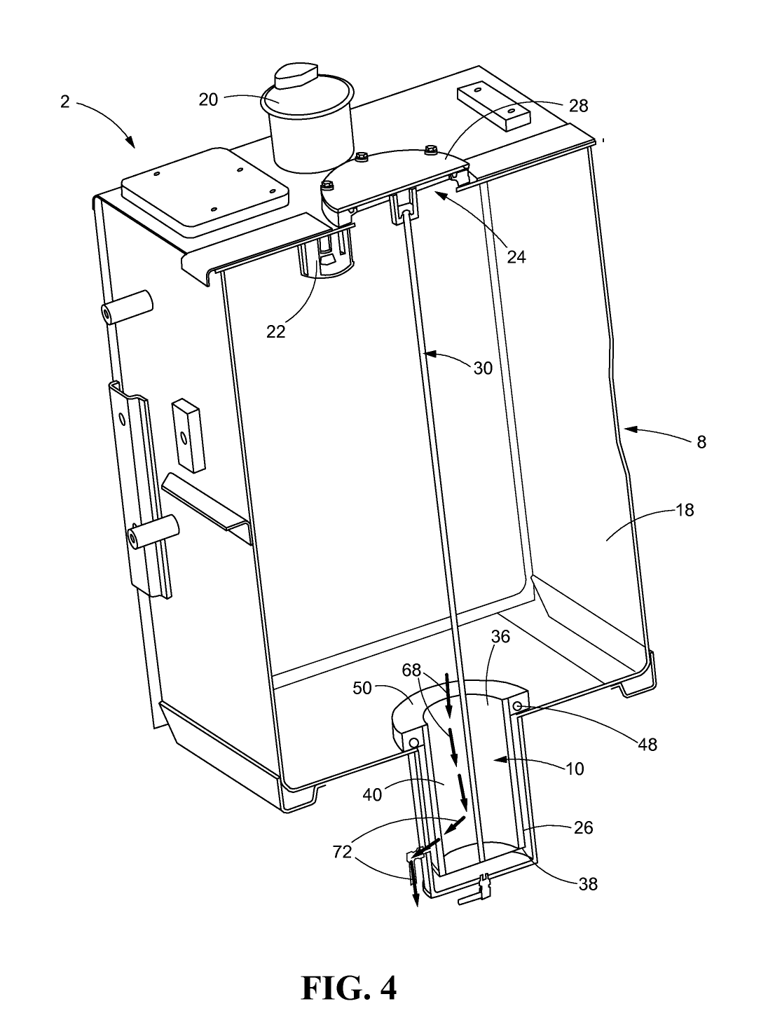

Referring now to FIGS. 2-4, a fuel filtration system employed within the fuel tank 8 is shown, in accordance with at least some embodiments of the present disclosure. FIG. 2 in particular shows a cross-sectional view of the fuel tank 8 of FIG. 1 taken along lines 2-2 thereof, while FIGS. 3 and 4 show front views thereof. As shown, the fuel filtration system may include the strainer 22 connected to the fuel tank opening 16 and/or the fuel tank cap 20, and the fuel filter 10 connected to the filter opening 24 via the filter shaft 30 and positioned within the sump 26.

With specific reference to FIG. 2 and, particularly, the strainer 22, it may be a coarse mesh or other rigid structure that may be employed for removing any rock pieces and other bigger pieces of dirt/contaminants from the incoming fuel. Accordingly, the strainer 22 may even be termed as a rock-catcher. The size and shape of the strainer 22 may vary depending upon the size and shape of the fuel tank opening 16 and the fuel tank cap 20. In at least some embodiments, the strainer 22 may be fitted (e.g., friction snapped) to the fuel tank opening 16, such that any fuel entering the fuel tank opening enters and passes through the strainer 22. A sealing mechanism (not visible) may also be provided between the mating surfaces of the strainer 22 and the fuel tank opening 16. The strainer 22 may be occasionally cleaned and/or replaced for continual rock/dirt separation from fuel.

Turning now to FIGS. 3 and 4 in conjunction with FIG. 2, in contrast to the strainer 22 which separates rock and other bigger pieces of contaminants entering the fuel tank 8, the fuel filter 10 may be employed for removing any contaminants that remain in the incoming fuel after passing the strainer. In at least some embodiments, the fuel filter 10 may be a cylindrical, disposable or reusable filter having an open top end 36, a bottom cap 38 and a filter body 40. Although not shown, the filter body 40 may have a pleated surface for improved filtration and radial beading for maintaining stability and spacing of the pleated surface during and after the filtering operation and, for preventing bunching of the pleats thereof, thereby maximizing the efficiency, capacity and life of the fuel filter. The fuel filter 10 and, particularly, the filter body 40 of the fuel filter may be constructed of a high efficiency cellulosic or synthetic medium to filter and clean smaller particles of dust, debris, and other contaminants from the fuel entering the fuel tank 8. Depending upon the rating (e.g., size) of the contaminants desired to be filtered, the rating of the filter media may vary. Furthermore, the fuel filter 10 may be designed to provide an inside-out filtering of the fuel, as described in greater detail below, such that fuel may enter the fuel filter through the open top end 36 and may exit the fuel filter outwards into the fuel tank 8 through the surfaces of the filter body 40. Among other benefits, this may ensure that the fuel filter 10 contains debris on the inside of the fuel filter so that it does not fall out when removing the fuel filter from the fuel tank 8.

Additionally, the fuel filter 10 may be positioned within the sump 26 of the fuel tank 8. The sump 26 may be provided as a recess downwardly depending from a bottom surface 42 of the fuel tank body 18 or, alternatively, the fuel tank body may have a false bottom (not shown) above the bottom surface 42 and defining the sump for holding the fuel filter. By virtue of providing the sump 26 and, installing the fuel filter 10 within the sump, the fuel filter may be positioned in a stable position within the fuel tank without risk of any wobbling or purging filtered contaminants back into the fuel stored within the fuel tank 8. Furthermore, by providing the sump 26 with a reduced diameter relative to the fuel tank as a whole, it may be ensured that any fuel leaving the fuel tank 8 passes through the fuel filter 10 and is filtered before exiting the fuel tank. Accordingly, the sump 26 and the fuel filter 10 positioned within the sump provide for an effective mechanism of filtering fuel within the fuel tank irrespective of the level of fuel therein. The sump 26 may also save any space that may have been wasted by the fuel filter 10 occupying the space within the fuel tank body 18, while providing ease of serviceability such that any dirt collected on the bottom of the fuel tank 8 may be easily removed by providing an opening at the bottom of the sump.

The sump 26 may additionally be provided with a fuel outlet nozzle 44 for exiting fuel from the fuel tank 8, as well as a water drain 46 for draining any water that coalesces at the bottom of the sump. A seal gasket or sealing mechanism 48, such as a rubber gasket or an O-ring, may also be provided between an inner wall of the sump and an outer surface of the filter body 40 for holding the fuel filter in a stable position, as shown in FIG. 3. Alternatively, as shown in FIG. 4, the fuel filter 10 may be provided with an outwardly extending flange 50 and the sealing mechanism 48 may be provided in between the flange and the bottom surface 42 of the fuel tank body 18. In other embodiments, other mechanisms for securely holding the fuel filter 10 within the sump 26 may be employed as well.

In addition to being securely positioned within the sump 26, the fuel filter 10 may be connected to the filter shaft 30, which in turn may be connected to the cover 28 of the filter opening 24. Specifically, the filter shaft 30 may be a hollow or solid shaft that may be connected at one end thereof to the cover 28, in a manner described below. The other end of the filter shaft 30 may extend through the open top end 36 of the fuel filter 10, through the center of the filter body 40 and may be secured to the bottom cap 38 thereof. In at least some embodiments, the bottom cap 38 may have an upwardly extending flange portion 56 with threads on an inner surface thereof that may mate with outer threads on a bottom surface of the filter shaft 30 to connect the filter shaft to the fuel filter 10. Notwithstanding the fact that in the present embodiment, the filter shaft 30 is threaded to the bottom cap 38, in at least some other embodiments, the filter shaft may be connected by other mechanisms, such as, adhesives, screws, etc., to the bottom cap as well. Furthermore, the filter shaft 30 need not always extend through the entire filter body 40, as described above. Rather, in at least some embodiments, the filter shaft 30 may be connected to the open top end 36 of the fuel filter 10, or may extend partially within the fuel filter.

By virtue of passing the filter shaft 30 through the center of the filter body 40 and connecting to the bottom cap 38, the filter shaft may provide a steady installation and removal of the fuel filter 10. Furthermore, the filter shaft 30 extending through the fuel filter 10 may provide stable guidance to install and position the fuel filter 10 within the sump 26.

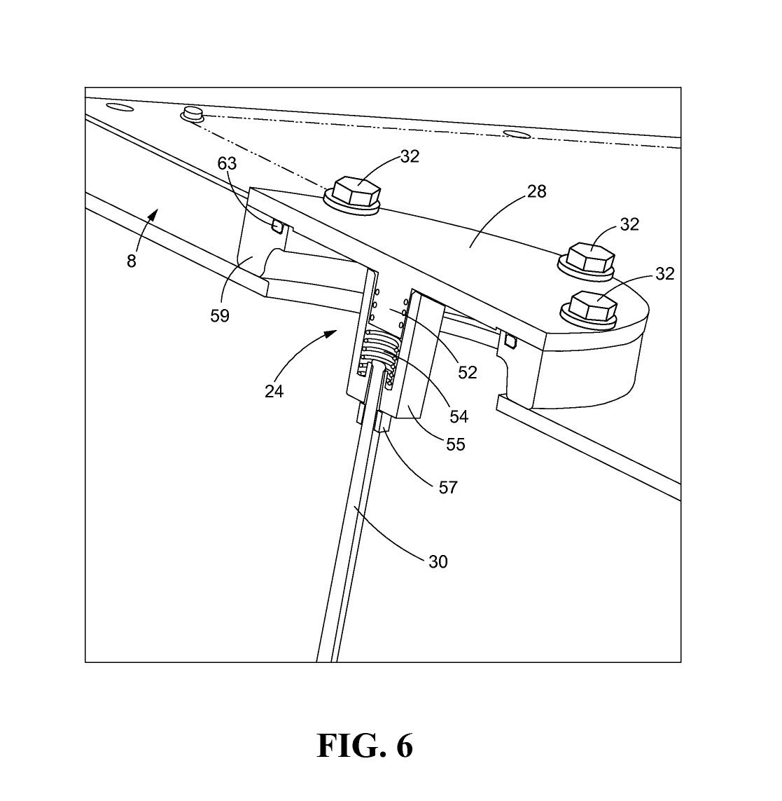

Referring now to FIGS. 6 and 7 in conjunction with FIGS. 3 and 4, the filter shaft 30 may be connected to the cover 28 by a spring interface, described below. Specifically, the cover 28 may be provided with a downwardly depending boss 52 that may rest on a spring 54 positioned within a cup 55. The cup 55 may be threaded onto a bolt 57 connected to the filter shaft 30. A ring 59 having an O-ring groove 61 for positioning an O-ring 63 may be positioned about the filter opening 24 on which the cover 28 may rest and be bolted to by the plurality of bolts 32. Thus, by virtue of positioning the cover 28 onto the ring 63, the boss 52 may rest snuggly within and press onto the spring 54, which in turn may provide some movement to the filter shaft 30 relative to the cover and avoid breakage thereof. In other embodiments, other mechanisms for connecting the filter shaft 30 to the cover 28 may be employed as well.

Thus, when the fuel filter 10 is to be removed from the fuel tank 8 for either cleaning or replacement, the cover 28 may be opened (e.g., by unscrewing the bolts 32) and the cup 55 may be pulled up. As the cup 55 is pulled up, the filter shaft 30, which is connected to the cup is also pulled up, thereby pulling the fuel filter 10 therealong. By virtue of the fuel filter 10 processing the fuel along an inside-out flow path, the debris is necessarily caught with the fuel filter and does not fall out when the fuel filter is removed. The filter shaft 30 may or may not be detached from the cup 55 to retrieve the fuel filter 10 from the fuel tank 8. Subsequent to removing the fuel filter 10 from the fuel tank 8, the filter shaft 30 may be disconnected from the fuel filter and cleaned and/or replaced. The cleaned or replaced fuel filter 10 may then again be connected (e.g., threaded) to the filter shaft 30 and lowered into the fuel tank 8 through the filter opening 24. The filter shaft 30 may guide the fuel filter 10 into the sump 26 and position the fuel filter therein. The cover 28 may then be bolted back to the ring 63. Accordingly, the filter shaft 30 provides a convenient, easy and effective mechanism for replacing and/or cleaning the fuel filter 10 while enabling the fuel filter to be positioned in the sump 26 for effective filtering of all of the fuel within the fuel tank 8.

### INDUSTRIAL APPLICABILITY

In general, a filtration system for filtering fuel on egress from a fuel tank in a fuel system is described above. The filtration system may include a strainer for catching rocks and/or bigger particles of dirt and contamination as fuel enters the fuel tank, as well as a fuel filter positioned on an exit of the fuel tank to filter any remaining contaminants from the fuel as it leaves the fuel tank. The fuel filter may be positioned within a sump provided on a bottom surface of the fuel tank to effectively utilize the entire fuel filter body to filter all fuel irrespective of the level of fuel within the fuel tank.

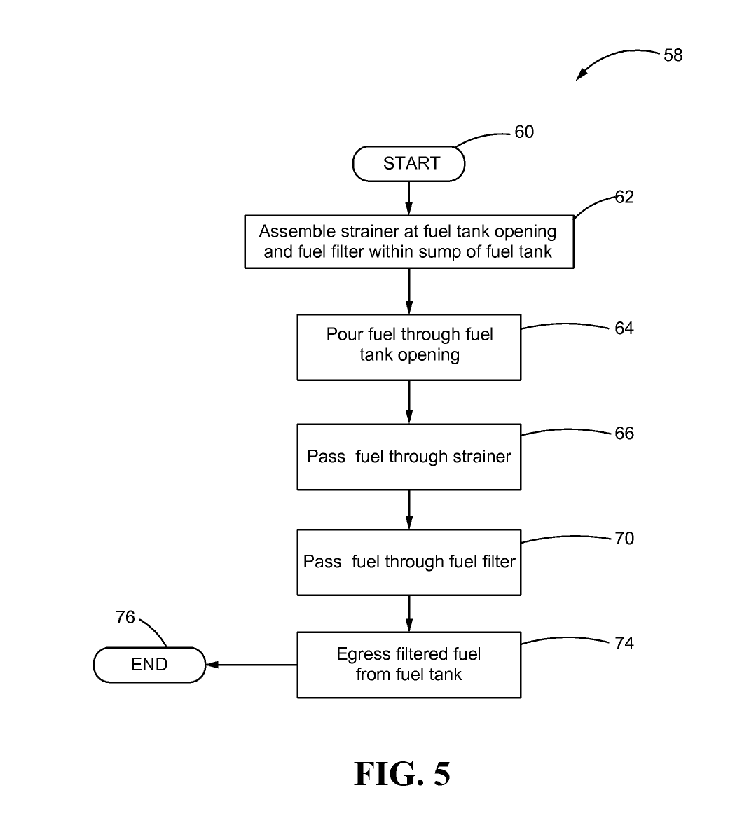

A method 58 of filtering fuel entering the fuel tank 8 is shown with respect to FIG. 5. After starting at a step 60, the strainer 22 and the fuel filter 10 may first be assembled within the fuel tank 8 at a step 62. As described above, the strainer 22 may be connected to the fuel tank opening 16 and/or the fuel tank cap 20 by threaded connections, frictional nubs or the like, such that any fuel entering the fuel tank opening automatically enters through the strainer. Relatedly, the fuel filter 10 may be assembled (or installed) within the fuel tank 8 by securing the fuel filter to one end of the filter shaft 30, connecting the other end of the filter shaft to the cover 28 by the spring interface described above, lowering the filter shaft and the fuel filter within the fuel tank body 18, positioning the fuel filter within the sump 26 and bolting the cover 28 to the ring 63 for securing the fuel filter in position.

Subsequent to assembling the strainer 22 and the fuel filter 10 within the fuel tank 8 at the step 62, the fuel desired to be stored within the fuel tank is poured or pumped through the fuel tank opening 16 at a step 64. Next, at a step 66, the entering fuel is passed through the strainer 22 to remove any pieces of rock or bigger dirt from the incoming fuel to obtain a fuel cleared to a first level, as schematically illustrated by arrows 68. By virtue of connecting the strainer 22 to the fuel tank opening 16, any fuel coming into the fuel tank 8 is automatically passed through the strainer. The strainer 22 may be occasionally removed from the fuel tank 8 to clean and/or replace the strainer. The fuel cleared to the first level 68 is then passed through the fuel filter 10 at a step 70 to obtain a fuel cleared to a second level, as also illustrated schematically by arrows 72.

Thus, the fuel cleared to the first level 68 by the strainer 22 follows an inside-out filtration through the fuel filter 10. In other words, the fuel cleared to the first level 68 is directed into the center of the filter body 40 through the open top end 36 and the filtered fuel (fuel cleared to the second level 72) passes through the walls of the filter body to an outside surface of the fuel filter. Thus, the flow of fuel through the fuel filter 10 is uni-directional, that is, from inside the fuel filter to the outside thereof. By virtue of providing such a uni-directional inside-out flow of fuel, the fuel filter provides several advantages.

First, any contamination that is removed from the first clean fuel is trapped within the fuel filter 10 without any danger of that contamination mixing back into the fuel. Secondly, as the fuel filter 10 is pulled up through the fuel tank body 18 for replacing and/or cleaning, any contamination that is trapped within the fuel filter remains safely inside the fuel filter even if the fuel tank 8 is filled completely with fuel, thereby preventing releasing (e.g., purging) of the contaminants back into the fuel. Furthermore, the fuel filter 10, which may in at least some embodiments, separate water from the fuel may be easily drained out from the bottom of the sump 26 by way of the water drain 46.

Thus, any incoming fuel entering the fuel tank 8 undergoes a two-step filtration process: first through the strainer 22 to remove bigger pieces of contamination; and second through the fuel filter 10 in an inside-out flow to remove any remaining smaller pieces of contamination. The clean fuel (e.g., the fuel cleared to the second level 72) then egresses the fuel tank 8 through the fuel outlet nozzle 44 at a step 74. In particular, the filtered fuel from the fuel outlet nozzle 44 flows via the fuel line 12 into the engine 6 for combustion, as shown and described with respect to FIG. 1. After combustion in the engine 6, any non-combusted fuel is returned to the fuel tank 8 via the return fuel line 14 for re-filtration and re-combustion, as outlined above by the steps 66, 70 and 74. In at least some embodiments, the return fuel from the return fuel line 14 may not pass through the strainer 22 and may only pass through the fuel filter 10 for filtration in which case only the steps 70 and 74 may be repeated. The process then ends at a step 76.

It will be understood that although the steps 64, 66 and 70 of pouring fuel and passing fuel through the strainer 22 and the fuel filter 10, respectively, have been described above as happening one after another, there may not necessarily be a time lag between those steps. Rather, those steps may happen simultaneously such that the fuel may be continuously poured though the fuel tank opening and filtered through the strainer and the fuel filter.

Thus, by virtue of providing the fuel filter and the strainer and positioning the fuel filter within a sump, any incoming fuel may be automatically filtered before storing and/or supplying that fuel for combustion in an internal combustion engine of a machine or the like. Positioning the fuel filter in the sump of the fuel tank opening also provides an additional advantage insofar as the fuel filter is invisible to a customer when filling the fuel tank, consumes less space compared to conventional fuel filters, performs filtering without the requirement of any pumps or other special equipment, is simple to maintain and economical to use.

Accordingly, the present disclosure provides a high efficiency, durable and inexpensive filtering mechanism for filtering fuel to alleviate (or possibly even completely eliminate) contaminants from the fuel, thereby improving fuel stability as well as increasing the performance and reliability of engines employing the filtered fuel.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A filtered fuel system, comprising:
a strainer connected to a fuel tank opening of a fuel tank, the strainer removing a first type of contaminant; and
a fuel filter positioned within a sump of the fuel tank, the fuel filter filtering a second type of contaminant and connected to a filter opening of the fuel tank through a filter shaft.

2. The filtered fuel system of claim 1, wherein the first type of contaminant is larger than the second type of contaminant.

3. The filtered fuel system of claim 1, wherein the fuel filter comprises:
a filter body having a filter media;
an top end connected to a top portion of the filter body; and
a bottom cap connected to a bottom portion of the filter body.

4. The filtered fuel system of claim 1, wherein the sump is a recess in a bottom surface of the fuel tank.

5. The filtered fuel system of claim 4, wherein the sump further comprises:
a fuel outlet nozzle for egressing filtered fuel from the fuel tank; and
a water drain for draining water coalesced on a bottom surface of the sump.

6. The filtered fuel system of claim 1, wherein the fuel filter is held in position within the sump through a sealing mechanism positioned between an outer surface of the fuel filter and an inner surface of the sump.

7. The filtered fuel system of claim 1, wherein the fuel filter is held in position within the sump by way of flanges connected to a bottom surface of the fuel tank.

8. The filtered fuel system of claim 1, wherein the filter shaft extends through an open top end of the fuel filter and connects at a first end thereof to a bottom cap of the fuel filter.

9. The filtered fuel system of claim 8, wherein a second end of the filter shaft is connected to a cover by a spring interface.

10. The filtered fuel system of claim 9, wherein the cover covers the filter opening.

11. A method of filtering fuel, the method comprising:
providing a fuel filter connected to a filter shaft;
assembling the fuel filter within a sump of a fuel tank;
passing fuel through a fuel tank opening of the fuel tank; and
filtering the fuel through the fuel filter along an inside-out flow path.

12. The method of claim 11, further comprising egressing filtered fuel from the fuel tank through a fuel outlet nozzle.

13. The method of claim 11, wherein filtering the fuel further comprises:
passing the fuel through a strainer connected to the fuel tank opening of the fuel tank to obtain a fuel cleared to a first level; and
passing the fuel cleared to the first level from into the fuel filter to an outside surface thereof to obtain a fuel cleared to a second level.

14. The method of claim 11, wherein assembling the fuel filter within the fuel tank comprises:
connecting the fuel filter to one end of the filter shaft;
connecting another end of the filter shaft to a cover of a filter opening through a spring interface;
lowering the fuel filter and the filter shaft into the filter opening;
positioning the fuel filter into the sump; and
closing the filter opening with the cover.

15. A fuel system, comprising:
a fuel tank having a fuel tank body, a fuel tank opening, a filter opening, and a sump formed in a recess on a bottom surface of the fuel tank body;
a fuel filter positioned within the sump of the fuel tank and connected to one end of a filter shaft, a second end of the filter shaft connected to a cover covering the filter opening; and
a strainer fitted to the fuel tank opening.

16. The fuel system of claim 15, wherein the sump is formed substantially directly below the filter opening.

17. The fuel system of claim 15, wherein the sump further comprises a fuel outlet nozzle on a side surface of the sump and a water drain on a bottom surface of the sump.

18. The fuel system of claim 15, wherein the strainer is a coarse mesh.

19. The fuel system of claim 15, wherein the fuel filter is positioned within the sump by way of a sealing mechanism positioned in between the fuel filter and the sump.

20. The fuel system of claim 15, wherein the one end of the filter shaft passes through an top end of the fuel filter and threads to a bottom cap of the fuel filter.
